(19) United States
(12) Patent Application Publication
(10) Pub. No.: US 2026/0097455 A1
(43) Pub. Date: Apr. 9, 2026

(54) WELDING WIRE CUTTING STRUCTURE

(71) Applicant: Guangdong Kelongwei Automation Equipment Co., Ltd., Dongguan (CN)

(72) Inventors: Jincai SU, Dongguan (CN); Chunfu CHEN, Dongguan (CN)

(21) Appl. No.: 19/417,246

(22) Filed: Dec. 11, 2025

(30) Foreign Application Priority Data
Apr. 23, 2025 (CN) 202510517208.9

(51) Int. Cl. B23K 35/40

(52) U.S. Cl. CPC B23K 35/40

(57) ABSTRACT

The invention discloses a welding wire cutting structure, comprising a welding wire cutting support, an upper plate, a lower plate, a welding wire base plate and a pressure holding cylinder. The upper and lower plates move vertically towards each other, with an upper cutter connected to the upper plate’s lower end and a lower cutter to the lower plate’s upper end. The pressure holding cylinder, mounted at the support’s lower end, has multiple movable cavities each equipped with a piston linked to a pressure holding spring. The base plate is provided with flat holes for welding wires to pass through, preventing turnover. The upper and lower cutters cut simultaneously to avoid burrs and offset at the cutting position. The lower cutter’s arc-shaped edge guides position correction, and the pistons independently press each welding wire, ensuring no mutual interference during cutting.

### CROSS-REFERENCE TO RELATED APPLICATIONS

This application claims the benefit of priority from Chinese Patent Application No. 202510517208.9, filed on April 23, 2025. The content of the aforementioned applications, including any intervening amendments thereto, is incorporated herein by reference.

### TECHNICAL FIELD

The present invention relates to the technical field of silicon wafer series welding, particularly to a welding wire cutting structure.

### BACKGROUND

Photovoltaic solar silicon wafers constitute the core component of solar power generation systems and represent the most valuable part of solar power generation systems. The function of silicon wafers is to convert solar energy into electrical energy, and then electrical energy is stored in batteries or directly powers loads. In BC cells (a back contact cell,wherein it can be combined with various routes), after being pulled out from the welding wire feeding frame, the welding wire is cut according to the required length. In the existing cutting structure, the upper cutter moves alone or the lower cutter moves alone, facilitating the occurrence of burrs and up-and-down offset of the welding wire at the cutting position. When passing through the cutting structure, the welding wire is prone to rollover at a certain angle, and a plurality of welding wires will affect each other when pressed and held by a single cylinder structure simultaneously.

### SUMMARY

An objective of the invention is to provide a welding wire cutting structure, wherein it can effectively prevent the welding wire from turning over when passing through, independently press and hold a single welding wire for cutting, and avoid the offset and burr of the welding wire during cutting.

To achieve this objective, the present invention employs the following technical solutions:

1. A welding wire cutting structure, including a welding wire cutting support, a welding wire cutting upper plate and a welding wire cutting lower plate. The welding wire cutting upper plate and the welding wire cutting lower plate move towards each other in the vertical direction; the lower end of the welding wire cutting upper plate is connected with an upper cutter; the upper end of the welding wire cutting lower plate is connected with a lower cutter; the lower end of the welding wire cutting support is provided with a welding wire base plate and a welding wire pressure holding cylinder; a plurality of movable cavities are distributed on the welding wire pressure holding cylinder; a piston is installed in each movable cavity; the upper end of the piston is connected with a pressure holding spring; a plurality of flat holes are distributed on the welding wire base plate and the lower end of the piston is above the flat holes.

As a preferred technical solution, a welding wire cutting motor is installed at the upper end of the welding wire cutting support, the driving end of the welding wire cutting motor is connected with a welding wire cutting cam, and the middle part of the upper end of the welding wire cutting upper plate and the middle part of the lower end of the welding wire cutting lower plate are both provided with welding wire cutting guide holes, and the welding wire cutting cams are located inside two welding wire cutting guide holes.

As a preferred technical solution, both sides of the welding wire cutting support are provided with vertical sliding rails along the vertical direction, and vertical sliders are fixed on the welding wire cutting upper plate and the welding wire cutting lower plate, and the vertical sliders slide on the vertical sliding rails.

As a preferred technical solution, the upper end of the lower cutter is provided with a plurality of kerfs, and the kerfs are arc-shaped with the upper size larger than the lower size.

As a preferred technical solution, a plurality of gas pipe joints are arranged at the side of the welding wire pressure holding cylinder, a ventilation area is arranged in the movable cavity, and one of the gas pipe joints is independently communicated with the ventilation area in one of the movable cavities.

As a preferred technical solution, a top part is fixed at the upper end of the movable cavity, and the upper end of the pressure holding spring is located in the middle of the top part.

As a preferred technical solution, both sides of the welding wire cutting upper plate are provided with elastic clips, both sides of the upper cutter are locked on the elastic clips, and the upper cutter is obliquely pressed on the lower cutter.

The beneficial effects of present invention: A welding wire cutting structure is provided; the welding wire passes through the flat hole to prevent the welding wire from turning over; the upper cutter and the lower cutter simultaneously move towards the middle to cut the welding wire, so that the cutting position of the welding wire will not incur burr and offset; and the knife edge position of the lower cutter is set in an arc shape to guide the welding wire to correct the position, and a plurality of sets of pistons independently press and hold the welding wire, so that a plurality of welding wires are not influenced by each other during cutting.

### BRIEF DESCRIPTION OF THE DRAWINGS

The present invention will now be described in further detail with reference to the drawings and embodiments.

FIG.1 is a schematic diagram of the first structure of a welding wire cutting structure according to the embodiment;

FIG.2 is a schematic diagram of the second structure of a welding wire cutting structure according to the embodiment;

FIG.3 is a schematic diagram of the third structure of a welding wire cutting structure according to the embodiment;

FIG.4 is a schematic diagram of the combined structure of the welding wire base plate and the welding wire pressure holding cylinder according to the embodiment;

FIG.5 is a combined partial sectional view of the welding wire base plate and the welding wire pressure holding cylinder according to the embodiment.

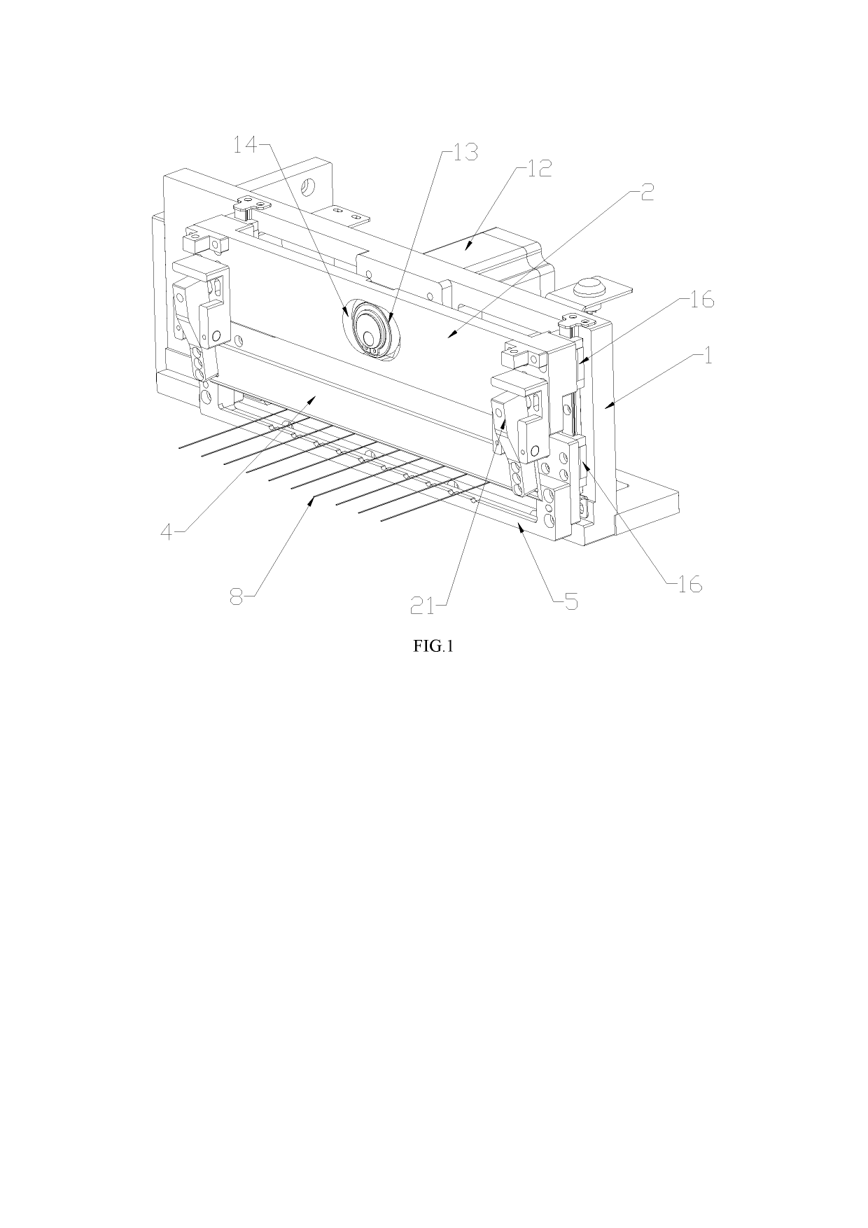

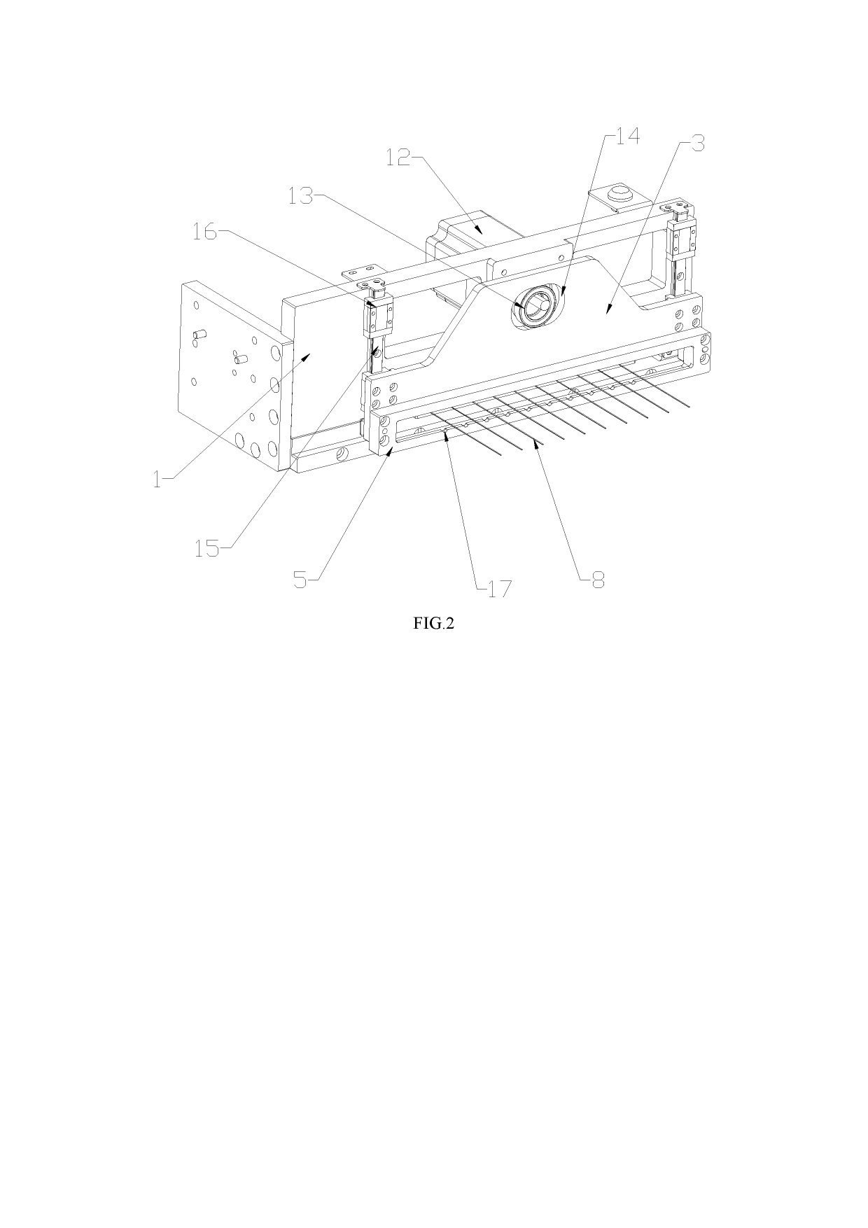

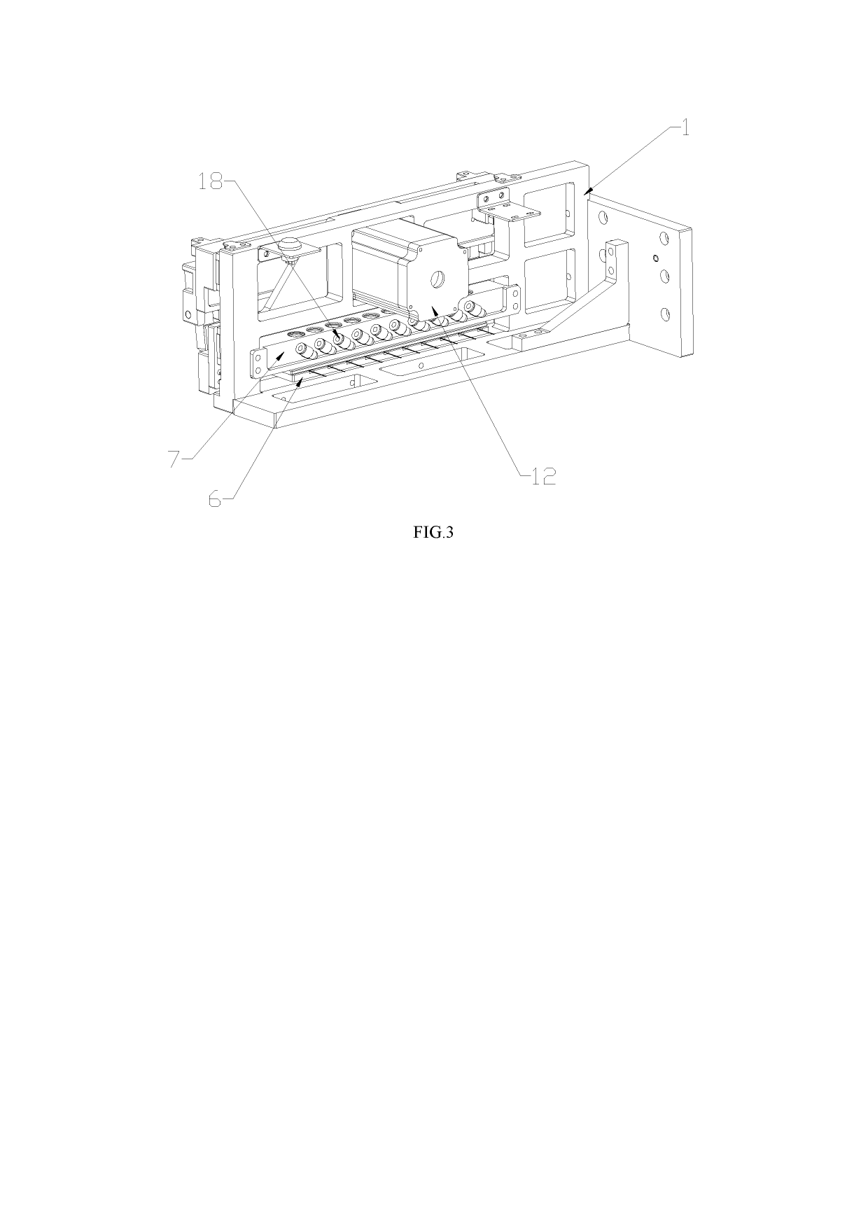

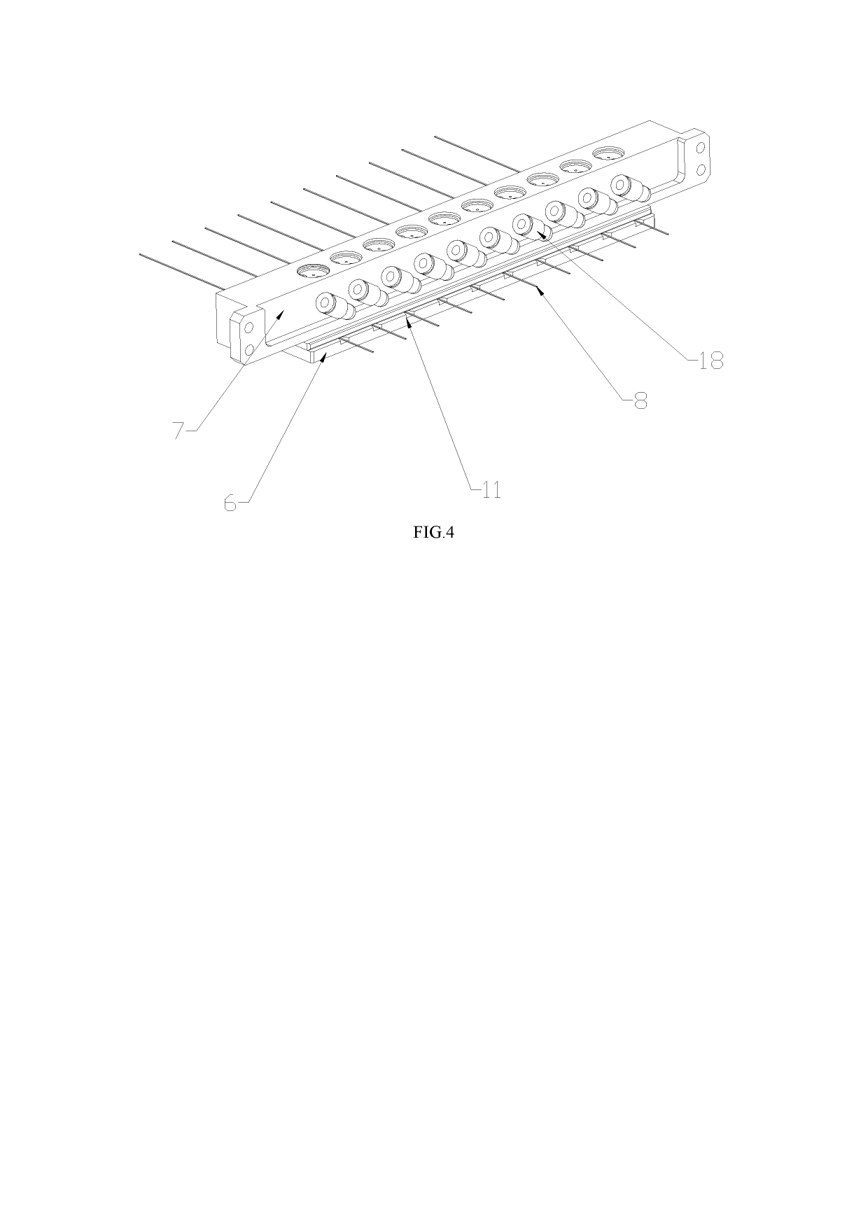

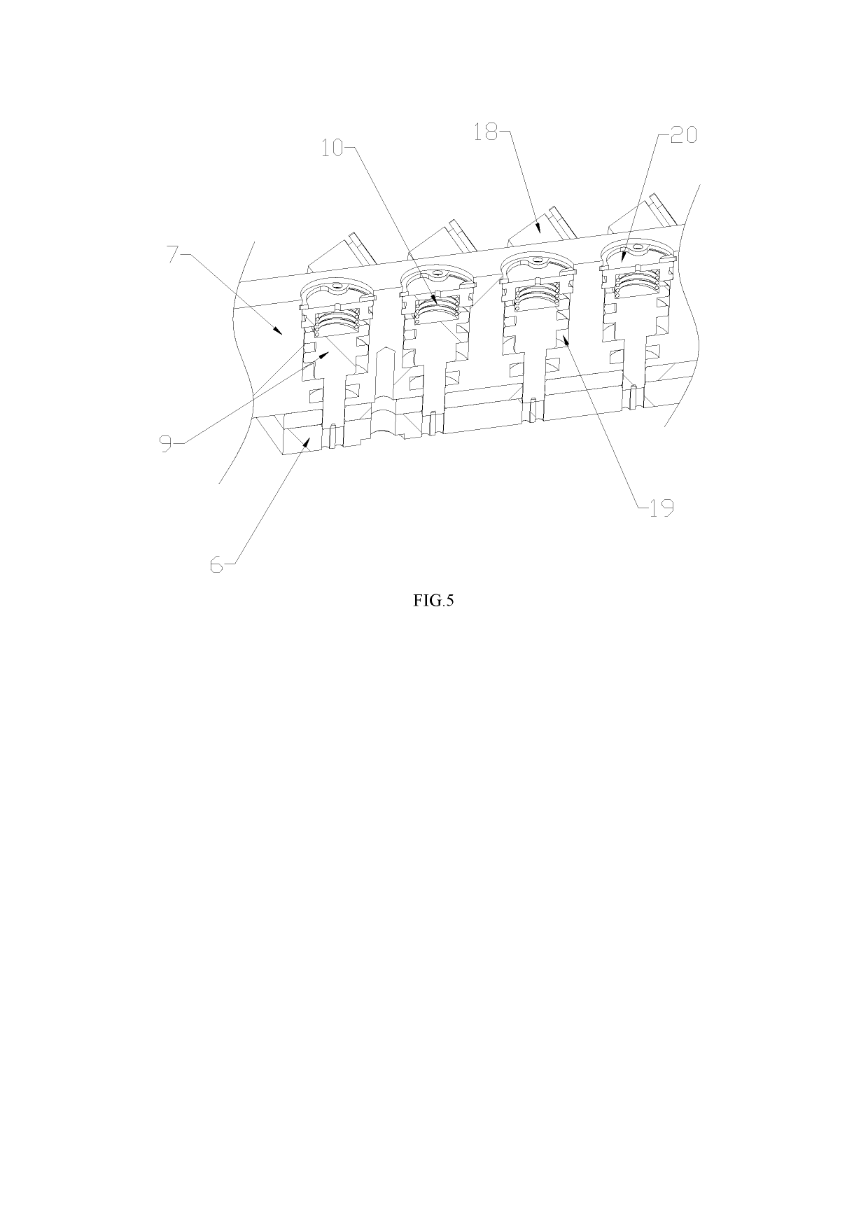

In FIGS. 1 to 5:

1. Welding wire cutting support; 2. Welding wire cutting upper plate; 3. Welding wire cutting lower plate; 4. Upper cutter; 5. Lower cutter; 6. Welding wire base plate; 7. Welding wire pressure holding cylinder; 8. Welding wire; 9. Piston; 10. Pressure holding spring; 11. Flat hole; 12. Welding wire cutting motor; 13. Welding wire cutting cam; 14. Welding wire cutting guide hole; 15. Vertical sliding rail; 16. Vertical slider; 17. Kerf; 18. Air pipe joint; 19. Ventilation area; 20. Top part; 21. Elastic clip.

### DETAILED DESCRIPTION OF EMBODIMENTS

The technical solution of the present invention will be further explained by specific embodiments with reference to the attached drawings.

As shown in FIGS. 1 to 5, in this embodiment, a welding wire cutting structure includes a welding wire cutting support 1, a welding wire cutting upper plate 2 and a welding wire cutting lower plate 3, wherein the welding wire cutting upper plate 2 and the welding wire cutting lower plate 3 move towards each other in the vertical direction; the lower end of the welding wire cutting upper plate 2 is connected with an upper cutter 4; the upper end of the welding wire cutting lower plate 3 is connected with a lower cutter 5; the lower end of the welding wire cutting support 1 is provided with a welding wire base plate 6 and a welding wire pressure holding cylinder 7; a plurality of movable cavities are distributed on the welding wire pressure holding cylinder 7; a piston 9 is installed in each movable cavity; the upper end of the piston 9 is connected with a pressure holding spring 10; a plurality of flat holes 11 are distributed on the welding wire base plate 6 and the lower end of the piston 9 is above the flat holes 11.

When the welding wire cutting upper plate 2 ascends and the welding wire cutting lower plate 3 descends, the welding wire 8 passes through the welding wire cutting support 1 and goes through the flat hole 11 on the welding wire base plate 6. At this time, the piston 9 moves downwards under the action of the pressure holding spring 10, and the single piston 9 stably presses the single welding wire 8 in the single flat hole 11. The welding wire cutting upper plate 2 and the welding wire cutting lower plate 3 move towards each other, and at the same time, are close to the welding wire 8 to cut the welding wire 8. Then, the welding wire pressure holding cylinder 7 is ventilated to make the piston 9 contract the pressure holding spring 10 upwards and release the cut welding wire 8, and the welding wire 8 can be placed in a suitable position.

The upper end of the welding wire cutting support 1 is equipped with a welding wire cutting motor 12, and the driving end of the welding wire cutting motor 12 is connected with a welding wire cutting cam 13. The welding wire cutting guide holes 14 are arranged in the middle of the upper end of the welding wire cutting upper plate 2 and the middle of the upper end of the welding wire cutting lower plate 3, and the welding wire cutting cam 13 is located inside the two welding wire cutting guide holes 14. Both sides of the welding wire cutting support 1 are provided with vertical sliding rails 15, vertical sliders 16 are fixed to the welding wire cutting upper plate 2 and the welding wire cutting lower plate 3 and the vertical slider 16 slides on the vertical sliding rail 15.

When the welding wire cutting motor 12 controls the rotation of the welding wire cutting cam 13, the two welding wire cutting guide holes 14 respectively control the movements of the welding wire cutting upper plate 2 and the welding wire cutting lower plate 3, and under the action of the vertical slider 16 and the vertical sliding rail 15, synchronously converge to the middle to cut the welding wire 8.

The upper end of the lower cutter 5 is provided with a plurality of kerfs 17, and the kerf 17 is arc-shaped with the upper size larger than the lower size. The arc-shaped structure enables the welding wire 8 to be positioned at the position set at the bottom under the force of the upper and lower cutters 5, so as to ensure no offset and smooth cutting.

A plurality of gas pipe joints 18 are arranged at the side of the welding wire pressure holding cylinder, a ventilation area 19 is arranged in the movable cavity, and one of the gas pipe joints 18 is independently communicated with the ventilation area 19 in one of the movable cavities.

When the welding wire 8 needs to be fixed for cutting, the air pipe joint 18 will not receive air, and the pressure holding spring 10 will press the piston 9 downward, so that the lower end of the piston 9 will stabilize the welding wire 8 in the flat hole 11.

When the welding wire 8 needs to be sent away after cutting, the air pipe joint 18 will be ventilated, and the ventilation area 19 in the movable cavity will be enlarged after receiving air, forcing the piston 9 to move upward, and the pressure holding spring 10 will squeeze. At this time, the lower end of the piston 9 will be opened, so that the welding wire 8 can move.

A top part 20 is fixed at the upper end of the movable cavity, and the upper end of the pressure holding spring 10 is located in the middle of the top part 20. Under the action of the top part 20, the pressure holding spring 10 can be relaxed and contracted in the movable cavity.

Both sides of the welding wire cutting upper plate are provided with elastic clips 21, both sides of the upper cutter 4 are locked on the elastic clips 21, and the upper cutter 4 is obliquely pressed on the lower cutter 5.

Under the action of the elastic clip 21, the lower end of the upper cutter 4 can cling to the lower cutter 5 in an inclined manner, thus maintaining the sharpness during cutting.

It should be noted that the above specific implementation methods merely represent preferred embodiments of the present invention and the technical principles employed. Within the scope of the disclosed technology, any modifications or substitutions readily conceivable by those skilled in the art should be encompassed within the scope of protection of the present invention.

What is claimed is:

1. A welding wire cutting structure, wherein it includes a welding wire cutting support, a welding wire cutting upper plate and a welding wire cutting lower plate. The welding wire cutting upper plate and the welding wire cutting lower plate move towards each other in the vertical direction; the lower end of the welding wire cutting upper plate is connected with an upper cutter; the upper end of the welding wire cutting lower plate is connected with a lower cutter; the lower end of the welding wire cutting support is provided with a welding wire base plate and a welding wire pressure holding cylinder; a plurality of movable cavities are distributed on the welding wire pressure holding cylinder; a piston is installed in each movable cavity; the upper end of the piston is connected with a pressure holding spring; a plurality of flat holes are distributed on the welding wire base plate and the lower end of the piston is above the flat holes.

2. A welding wire cutting structure as claimed in claim 1, wherein a welding wire cutting motor is installed at the upper end of the welding wire cutting support, the driving end of the welding wire cutting motor is connected with a welding wire cutting cam, and the middle part of the upper end of the welding wire cutting upper plate and the middle part of the lower end of the welding wire cutting lower plate are both provided with welding wire cutting guide holes, and the welding wire cutting cams are located inside two welding wire cutting guide holes.

3. A welding wire cutting structure as claimed in claim 1, wherein both sides of the welding wire cutting support are provided with vertical sliding rails along the vertical direction, and vertical sliders are fixed on the welding wire cutting upper plate and the welding wire cutting lower plate, and the vertical sliders slide on the vertical sliding rails.

4. A welding wire cutting structure as claimed in claim 1, wherein the upper end of the lower cutter is provided with a plurality of kerfs, and the kerfs are arc-shaped with the upper size larger than the lower size.

5. A welding wire cutting structure as claimed in claim 1, wherein a plurality of gas pipe joints are arranged at the side of the welding wire pressure holding cylinder, a ventilation area is arranged in the movable cavity, and one of the gas pipe joints is independently communicated with the ventilation area in one of the movable cavities.

6. A welding wire cutting structure as claimed in claim 1, wherein a top part is fixed at the upper end of the movable cavity, and the upper end of the pressure holding spring is located in the middle of the top part.

7. A welding wire cutting structure as claimed in claim 1, wherein both sides of the welding wire cutting upper plate are provided with elastic clips, both sides of the upper cutter are locked on the elastic clips, and the upper cutter is obliquely pressed on the lower cutter.
